(19) United States
(12) Patent Application Publication
(10) Pub. No.: US 2026/0280684 A1
(43) Pub. Date: Sep. 17, 2026

(54) METHOD, APPARATUS AND COMPUTER PROGRAM

(71) Applicant: Nokia Technologies Oy, Espoo (FI)

(72) Inventors: Ranganathan MAVUREDDI DHANASEKARAN, Munich (DE); Rakshesh PRAVINCHANDRA BHATT, Bangalore (IN)

(21) Appl. No.: 19/472,167

(22) PCT Filed: Mar. 11, 2024
(86) PCT No.: PCT/EP2024/056379

§ 371 Date: Oct. 3, 2025

(30) Foreign Application Priority Data
Apr. 14, 2023 (GB) 2305481.0

(51) Int. Cl. H04B 7/185; H04W 8/18; H04W 76/10; H04W 84/06

(52) U.S. Cl. CPC H04B 7/18513; H04W 8/186; H04W 76/10; H04W 84/06

(57) ABSTRACT

There is provided an apparatus comprising: means for receiving an indication that a first satellite supports store and forward mode during a connection establishment with the first satellite, and means for providing, to a gateway via the first satellite, a registration request comprising: i) a non-terrestrial network subscription concealed identifier, and ii) an indication of store and forward mode, wherein the subscription concealed identifier comprises an identifier for a non-terrestrial network gateway. The apparatus also comprising means for communicating with the first satellite using a store and forward mode.

### FIELD

The present application relates to a method, apparatus, and computer program for a wireless communication system.

### BACKGROUND

A communication system may be a facility that enables communication sessions between two or more entities such as user terminals, base stations/access points and/or other nodes by providing carriers between the various entities involved in the communications path. A communication system may be provided, for example, by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

### SUMMARY

According to an aspect, there is provided an apparatus comprising: means for receiving an indication that a first satellite supports store and forward mode during a connection establishment with the first satellite; means for providing, to a gateway via the first satellite, a registration request comprising: i) a non-terrestrial network subscription concealed identifier, and ii) an indication of store and forward mode, wherein the subscription concealed identifier comprises an identifier for a non-terrestrial network gateway; and means for communicating with the first satellite using a store and forward mode.

In an example, the non-terrestrial network subscription concealed identifier is associated with a user equipment.

In an example, the apparatus is arranged such that, when a user equipment is located in a remote location, the user equipment is able to connect to the first satellite, and unable to directly connect to a terrestrial network.

In an example, the means for providing comprises means for, in response to receiving the indication, providing the registration request.

In an example, the apparatus comprises: means for, based on the indication, generating the subscription concealed identifier, wherein the identifier for a non-terrestrial network gateway is included in the subscription concealed identifier.

In an example, the subscription concealed identifier is part of a network access identifier.

In an example, the identifier for the non-terrestrial network gateway is configured in a universal subscriber identity module.

In an example, the received indication is that: the first satellite supports the store and forward mode, and supports no further modes.

In an example, the indication of support for the store and forward mode comprised in the registration request message further indicates for a unified data management function to authorize the store and forward mode for communication between a user equipment and the first satellite.

In an example, the apparatus comprises: means for receiving authorisation information that the store and forward mode has been authorised; and wherein the means for communicating comprises: means for, in response to receiving the authorisation information, communicating with the first satellite using a store and forward mode

In an example, the identifier for the non-terrestrial network gateway comprises information associating the identifier for the non-terrestrial network gateway with one of: a home public land mobile network, and a visited public land mobile network.

In an example, the identifier for the non-terrestrial network gateway is comprised in a 5G globally unique temporary identifier.

In an example, one of: the apparatus is for a user equipment, the apparatus is comprised in the user equipment, and the apparatus is the user equipment.

According to an aspect, there is provided an apparatus comprising: means for providing, to a user equipment, an indication that a first satellite supports store and forward mode during a connection establishment with the user equipment; means for receiving, from the user equipment, a registration request comprising a non-terrestrial network gateway subscription concealed identifier and an indication of store and forward mode; means for determining, based on an identifier for a non-terrestrial network gateway comprised within the non-terrestrial network gateway subscription concealed identifier, a gateway to forward the registration request to; means for forwarding the registration request to the determined gateway; and means for communicating with the user equipment using a store and forward mode.

In an example, the registration request is provided to the gateway via a second satellite.

In an example, the subscription concealed identifier is part of a network access identifier.

In an example, the indication of support for the store and forward mode comprised in the registration request message further indicates for a unified data management function to authorize the store and forward mode for communication between a user equipment and the first satellite.

In an example, the apparatus comprises: means for receiving, from a serving network, authorisation information that the store and forward mode has been authorised; and means for forwarding, to the user equipment, the authorisation information.

In an example, the identifier for the non-terrestrial network gateway comprises information associating the identifier for the non-terrestrial network gateway with one of: a home public land mobile network, and a visited public land mobile network.

In an example, the identifier for the non-terrestrial network gateway is comprised in a 5G globally unique temporary identifier.

In an example, one of: the apparatus is for a first satellite, the apparatus is comprised in the first satellite, and the apparatus is the first satellite.

In an example, the first satellite is without a feeder link to a terrestrial network.

According to an aspect, there is provided an apparatus comprising: means for receiving, from a first satellite, a registration request comprising a non-terrestrial network gateway subscription concealed identifier and an indication of store and forward mode; means for verifying the received non-terrestrial network gateway subscription concealed identifier which comprises an identifier for a non-terrestrial network gateway, based on a configured identifier for a non-terrestrial network gateway; and means for, based on the verifying, forwarding the registration request to a home network for authorization of store and forward mode for the first satellite.

In an example, the means for forwarding comprises: means for, in response to a successful verification, forwarding the registration request to a home network for authorization of store and forward mode for the first satellite.

In an example, the registration request is received from the first satellite via a second satellite.

In an example, the subscription concealed identifier is part of a network access identifier.

In an example, the indication of support for the store and forward mode comprised in the registration request message further indicates for a unified data management function to authorize the store and forward mode for communication between a user equipment and the first satellite.

In an example, the apparatus comprises: means for providing, to the first satellite, authorisation information that the store and forward mode has been authorised.

In an example, the identifier for the non-terrestrial network gateway comprises information associating the identifier for the non-terrestrial network gateway with one of: a home public land mobile network, and a visited public land mobile network.

In an example, the identifier for the non-terrestrial network gateway is comprised in a 5G globally unique temporary identifier.

In an example, one of: the apparatus is for a gateway, the apparatus is comprised in the gateway, and the apparatus is the gateway.

According to an aspect, there is provided a method comprising: receiving an indication that a first satellite supports store and forward mode during a connection establishment with the first satellite; providing, to a gateway via the first satellite, a registration request comprising: i) a non-terrestrial network subscription concealed identifier, and ii) an indication of store and forward mode, wherein the subscription concealed identifier comprises an identifier for a non-terrestrial network gateway; and communicating with the first satellite using a store and forward mode.

In an example, the non-terrestrial network subscription concealed identifier is associated with a user equipment.

In an example, the providing comprises: in response to receiving the indication, providing the registration request.

In an example, the method comprises: based on the indication, generating the subscription concealed identifier, wherein the identifier for a non-terrestrial network gateway is included in the subscription concealed identifier.

In an example, the subscription concealed identifier is part of a network access identifier.

In an example, the identifier for the non-terrestrial network gateway is configured in a universal subscriber identity module.

In an example, the received indication is that: the first satellite supports the store and forward mode, and supports no further modes.

In an example, the indication of support for the store and forward mode comprised in the registration request message further indicates for a unified data management function to authorize the store and forward mode for communication between a user equipment and the first satellite.

In an example, the method comprises: receiving authorisation information that the store and forward mode has been authorised; and wherein the communicating comprises: in response to receiving the authorisation information, communicating with the first satellite using a store and forward mode

In an example, the identifier for the non-terrestrial network gateway comprises information associating the identifier for the non-terrestrial network gateway with one of: a home public land mobile network, and a visited public land mobile network.

In an example, the identifier for the non-terrestrial network gateway is comprised in a 5G globally unique temporary identifier.

In an example, the method is performed by a user equipment.

According to an aspect, there is provided a method comprising: providing, to a user equipment, an indication that a first satellite supports store and forward mode during a connection establishment with the user equipment; receiving, from the user equipment, a registration request comprising a non-terrestrial network gateway subscription concealed identifier and an indication of store and forward mode; determining, based on an identifier for a non-terrestrial network gateway comprised within the non-terrestrial network gateway subscription concealed identifier, a gateway to forward the registration request to; forwarding the registration request to the determined gateway; and communicating with the user equipment using a store and forward mode.

In an example, the registration request is provided to the gateway via a second satellite.

In an example, the subscription concealed identifier is part of a network access identifier.

In an example, the indication of support for the store and forward mode comprised in the registration request message further indicates for a unified data management function to authorize the store and forward mode for communication between a user equipment and the first satellite.

In an example, the method comprises: receiving, from a serving network, authorisation information that the store and forward mode has been authorised; and means for forwarding, to the user equipment, the authorisation information.

In an example, the identifier for the non-terrestrial network gateway comprises information associating the identifier for the non-terrestrial network gateway with one of: a home public land mobile network, and a visited public land mobile network.

In an example, the identifier for the non-terrestrial network gateway is comprised in a 5G globally unique temporary identifier.

In an example, the method is performed by a first satellite.

In an example, the first satellite is without a feeder link to a terrestrial network.

According to an aspect, there is provided a method comprising: receiving, from a first satellite, a registration request comprising a non-terrestrial network gateway subscription concealed identifier and an indication of store and forward mode; verifying the received non-terrestrial network gateway subscription concealed identifier which comprises an identifier for a non-terrestrial network gateway, based on a configured identifier for a non-terrestrial network gateway; and based on the verifying, forwarding the registration request to a home network for authorization of store and forward mode for the first satellite.

In an example, the forwarding comprises: in response to a successful verification, forwarding the registration request to a home network for authorization of store and forward mode for the first satellite.

In an example, the registration request is received from the first satellite via a second satellite.

In an example, the subscription concealed identifier is part of a network access identifier.

In an example, the indication of support for the store and forward mode comprised in the registration request message further indicates for a unified data management function to authorize the store and forward mode for communication between a user equipment and the first satellite.

In an example, the method comprises: providing, to the first satellite, authorisation information that the store and forward mode has been authorised.

In an example, the identifier for the non-terrestrial network gateway comprises information associating the identifier for the non-terrestrial network gateway with one of: a home public land mobile network, and a visited public land mobile network.

In an example, the identifier for the non-terrestrial network gateway is comprised in a 5G globally unique temporary identifier.

In an example, the method is performed by a gateway.

According to an aspect, there is provided an apparatus comprising: at least one processor, and at least one memory storing instructions that, when executed by the at least one processor, cause the apparatus to perform: receiving an indication that a first satellite supports store and forward mode during a connection establishment with the first satellite; providing, to a gateway via the first satellite, a registration request comprising: i) a non-terrestrial network subscription concealed identifier, and ii) an indication of store and forward mode, wherein the subscription concealed identifier comprises an identifier for a non-terrestrial network gateway; and communicating with the first satellite using a store and forward mode.

In an example, the non-terrestrial network subscription concealed identifier is associated with a user equipment.

In an example, the providing comprises: in response to receiving the indication, providing the registration request.

In an example, the apparatus is caused to perform: based on the indication, generating the subscription concealed identifier, wherein the identifier for a non-terrestrial network gateway is included in the subscription concealed identifier.

In an example, the subscription concealed identifier is part of a network access identifier.

In an example, the identifier for the non-terrestrial network gateway is configured in a universal subscriber identity module.

In an example, the received indication is that: the first satellite supports the store and forward mode, and supports no further modes.

In an example, the indication of support for the store and forward mode comprised in the registration request message further indicates for a unified data management function to authorize the store and forward mode for communication between a user equipment and the first satellite.

In an example, the apparatus is caused to perform: receiving authorisation information that the store and forward mode has been authorised; and wherein the communicating comprises: in response to receiving the authorisation information, communicating with the first satellite using a store and forward mode

In an example, the identifier for the non-terrestrial network gateway comprises information associating the identifier for the non-terrestrial network gateway with one of: a home public land mobile network, and a visited public land mobile network.

In an example, the identifier for the non-terrestrial network gateway is comprised in a 5G globally unique temporary identifier.

In an example, one of: the apparatus is for a user equipment, the apparatus is comprised in the user equipment, and the apparatus is the user equipment.

According to an aspect, there is provided an apparatus comprising: at least one processor, and at least one memory storing instructions that, when executed by the at least one processor, cause the apparatus to perform: providing, to a user equipment, an indication that a first satellite supports store and forward mode during a connection establishment with the user equipment; receiving, from the user equipment, a registration request comprising a non-terrestrial network gateway subscription concealed identifier and an indication of store and forward mode; determining, based on an identifier for a non-terrestrial network gateway comprised within the non-terrestrial network gateway subscription concealed identifier, a gateway to forward the registration request to; forwarding the registration request to the determined gateway;

and communicating with the user equipment using a store and forward mode.

In an example, the registration request is provided to the gateway via a second satellite.

In an example, the subscription concealed identifier is part of a network access identifier.

In an example, the indication of support for the store and forward mode comprised in the registration request message further indicates for a unified data management function to authorize the store and forward mode for communication between a user equipment and the first satellite.

In an example, the method comprises: receiving, from a serving network, authorisation information that the store and forward mode has been authorised; and means for forwarding, to the user equipment, the authorisation information.

In an example, the identifier for the non-terrestrial network gateway comprises information associating the identifier for the non-terrestrial network gateway with one of: a home public land mobile network, and a visited public land mobile network.

In an example, the identifier for the non-terrestrial network gateway is comprised in a 5G globally unique temporary identifier.

In an example, one of: the apparatus is for a first satellite, the apparatus is comprised in the first satellite, and the apparatus is the first satellite.

In an example, the first satellite is without a feeder link to a terrestrial network.

According to an aspect, there is provided an apparatus comprising: at least one processor, and at least one memory storing instructions that, when executed by the at least one processor, cause the apparatus to perform:
receiving, from a first satellite, a registration request comprising a non-terrestrial network gateway subscription concealed identifier and an indication of store and forward mode; verifying the received non-terrestrial network gateway subscription concealed identifier which comprises an identifier for a non-terrestrial network gateway, based on a configured identifier for a non-terrestrial network gateway; and based on the verifying, forwarding the registration request to a home network for authorization of store and forward mode for the first satellite.

In an example, the forwarding comprises: in response to a successful verification, forwarding the registration request to a home network for authorization of store and forward mode for the first satellite.

In an example, the registration request is received from the first satellite via a second satellite.

In an example, the subscription concealed identifier is part of a network access identifier.

In an example, the indication of support for the store and forward mode comprised in the registration request message further indicates for a unified data management function to authorize the store and forward mode for communication between a user equipment and the first satellite.

In an example, the method comprises: providing, to the first satellite, authorisation information that the store and forward mode has been authorised.

In an example, the identifier for the non-terrestrial network gateway comprises information associating the identifier for the non-terrestrial network gateway with one of: a home public land mobile network, and a visited public land mobile network.

In an example, the identifier for the non-terrestrial network gateway is comprised in a 5G globally unique temporary identifier.

In an example, one of: the apparatus is for a gateway, the apparatus is comprised in the gateway, and the apparatus is the gateway.

According to an aspect, there is provided a computer program comprising instructions, which when executed by an apparatus, cause the apparatus to perform at least the following: receiving an indication that a first satellite supports store and forward mode during a connection establishment with the first satellite; providing, to a gateway via the first satellite, a registration request comprising: i) a non-terrestrial network subscription concealed identifier, and ii) an indication of store and forward mode, wherein the subscription concealed identifier comprises an identifier for a non-terrestrial network gateway; and communicating with the first satellite using a store and forward mode.

According to an aspect, there is provided a computer program comprising instructions, which when executed by an apparatus, cause the apparatus to perform at least the following: providing, to a user equipment, an indication that a first satellite supports store and forward mode during a connection establishment with the user equipment; receiving, from the user equipment, a registration request comprising a non-terrestrial network gateway subscription concealed identifier and an indication of store and forward mode; determining, based on an identifier for a non-terrestrial network gateway comprised within the non-terrestrial network gateway subscription concealed identifier, a gateway to forward the registration request to; forwarding the registration request to the determined gateway; and communicating with the user equipment using a store and forward mode.

According to an aspect, there is provided a computer program comprising instructions, which when executed by an apparatus, cause the apparatus to perform at least the following: receiving, from a first satellite, a registration request comprising a non-terrestrial network gateway subscription concealed identifier and an indication of store and forward mode; verifying the received non-terrestrial network gateway subscription concealed identifier which comprises an identifier for a non-terrestrial network gateway, based on a configured identifier for a non-terrestrial network gateway; and based on the verifying, forwarding the registration request to a home network for authorization of store and forward mode for the first satellite.

According to an aspect, there is provided a non-transitory computer readable medium comprising program instructions, that, when executed by an apparatus, cause the apparatus to perform: receiving an indication that a first satellite supports store and forward mode during a connection establishment with the first satellite; providing, to a gateway via the first satellite, a registration request comprising: i) a non-terrestrial network subscription concealed identifier, and ii) an indication of store and forward mode, wherein the subscription concealed identifier comprises an identifier for a non-terrestrial network gateway; and communicating with the first satellite using a store and forward mode.

According to an aspect, there is provided a non-transitory computer readable medium comprising program instructions, that, when executed by an apparatus, cause the apparatus to perform: providing, to a user equipment, an indication that a first satellite supports store and forward mode during a connection establishment with the user equipment; receiving, from the user equipment, a registration request comprising a non-terrestrial network gateway subscription concealed identifier and an indication of store and forward mode; determining, based on an identifier for a non-terrestrial network gateway comprised within the non-terrestrial network gateway subscription concealed identifier, a gateway to forward the registration request to; forwarding the registration request to the determined gateway; and communicating with the user equipment using a store and forward mode.

According to an aspect, there is provided a non-transitory computer readable medium comprising program instructions, that, when executed by an apparatus, cause the apparatus to perform: receiving, from a first satellite, a registration request comprising a non-terrestrial network gateway subscription concealed identifier and an indication of store and forward mode; verifying the received non-terrestrial network gateway subscription concealed identifier which comprises an identifier for a non-terrestrial network gateway, based on a configured identifier for a non-terrestrial network gateway; and based on the verifying, forwarding the registration request to a home network for authorization of store and forward mode for the first satellite.

According to an aspect, there is provided an apparatus comprising: circuitry configured to perform: receiving an indication that a first satellite supports store and forward mode during a connection establishment with the first satellite; circuitry configured to perform: providing, to a gateway via the first satellite, a registration request comprising: i) a non-terrestrial network subscription concealed identifier, and ii) an indication of store and forward mode, wherein the subscription concealed identifier comprises an identifier for a non-terrestrial network gateway; circuitry configured to provide: communicating with the first satellite using a store and forward mode.

According to an aspect, there is provided an apparatus comprising: circuitry configured to perform: providing, to a user equipment, an indication that a first satellite supports store and forward mode during a connection establishment with the user equipment; circuitry configured to perform: receiving, from the user equipment, a registration request comprising a non-terrestrial network gateway subscription concealed identifier and an indication of store and forward mode; circuitry configured to perform: determining, based on an identifier for a non-terrestrial network gateway comprised within the non-terrestrial network gateway subscription concealed identifier, a gateway to forward the registration request to; circuitry configured to perform: forwarding the registration request to the determined gateway; circuitry configured to perform: communicating with the user equipment using a store and forward mode.

According to an aspect, there is provided an apparatus comprising: circuitry configured to perform: receiving, from a first satellite, a registration request comprising a non-terrestrial network gateway subscription concealed identifier and an indication of store and forward mode; circuitry configured to perform: verifying the received non-terrestrial network gateway subscription concealed identifier which comprises an identifier for a non-terrestrial network gateway, based on a configured identifier for a non-terrestrial network gateway; circuitry configured to perform: based on the verifying, forwarding the registration request to a home network for authorization of store and forward mode for the first satellite. According to an aspect, there is provided a computer product stored on a medium may cause an apparatus to perform the methods as described herein.

According to an aspect, there is provided a non-transitory computer readable medium comprising program instructions, that, when executed by an apparatus, cause the apparatus to perform the methods as described herein.

According to an aspect, there is provided an electronic device may comprise apparatus as described herein.

In the above, various aspects have been described. It should be appreciated that further aspects may be provided by the combination of any two or more of the various aspects described above.

Various other aspects and further embodiments are also described in the following detailed description and in the attached claims.

According to some aspects, there is provided the subject matter of the independent claims. Some further aspects are defined in the dependent claims. The embodiments that do not fall under the scope of the claims are to be interpreted as examples useful for understanding the disclosure.

### List of Abbreviations:

AF: Application Function
AMF: Access and Mobility Management Function
AN: Access Network
BS: Base Station
CN: Core Network
DL: Downlink
eNB: eNodeB
gNB: gNodeB
IIoT: Industrial Internet of Things
LTE: Long Term Evolution
NEF: Network Exposure Function
NG-RAN: Next Generation Radio Access Network
NF: Network Function
NR: New Radio
NRF: Network Repository Function
NW: Network
MS: Mobile Station
PCF Policy Control Function
PLMN: Public Land Mobile Network
RAN: Radio Access Network
RF: Radio Frequency
SMF: Session Management Function
UE: User Equipment
UDR: Unified Data Repository
UDM: Unified Data Management
UL: Uplink
UPF: User Plane Function
3GPP: 3rd Generation Partnership Project
5G: 5th Generation
5GC: 5G Core network
5G-AN: 5G Radio Access Network
5GS: 5G System

### DESCRIPTION OF FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4 shows a schematic representation of coverage areas for a non-terrestrial network;

FIG. 5 shows a schematic representation of a system-level view of a non-terrestrial network communicating with a terrestrial network;

FIG. 6 shows an example signalling diagram between a user equipment, non-terrestrial network entities, and terrestrial network entities;

FIG. 7 shows a schematic representation of a subscriber concealed identifier;

FIG. 8 shows a further schematic representation of a subscriber concealed identifier;

FIG. 9 shows an example method flow diagram performed by an apparatus;

FIG. 10 shows another example method flow diagram performed by an apparatus;

FIG. 11 shows another example method flow diagram performed by an apparatus; and

FIG. 12 shows a schematic representation of a non-volatile memory medium storing instructions which when executed by a processor allow a processor to perform one or more of the steps of the method of FIGS. 9 to 11.

### DETAILED DESCRIPTION

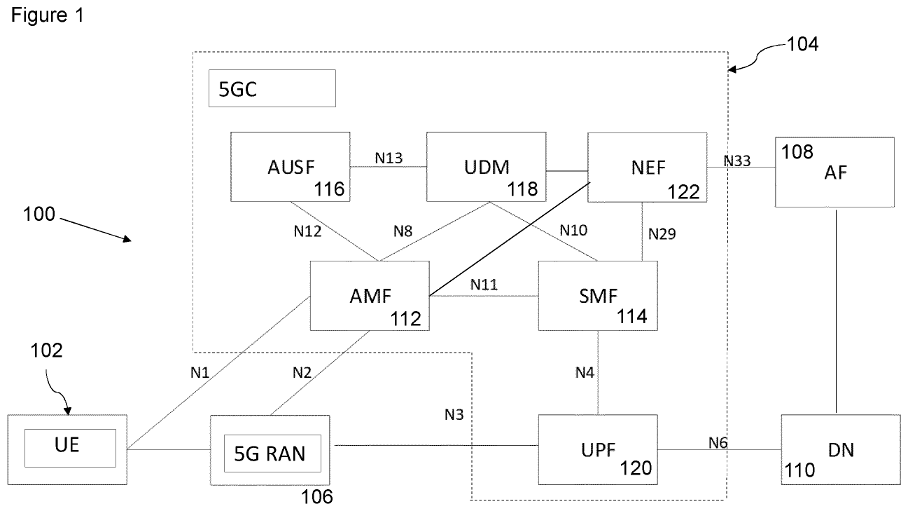

Before explaining in detail some examples of the present disclosure, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices/terminals or user apparatuses, and/or user equipments (UE), and/or machine-type communication devices 102 are provided wireless access via at least one base station (not shown) or similar wireless transmitting and/or receiving node or point. A communication device is provided with an appropriate signal receiving and transmitting apparatus for enabling communications, for example enabling access to a communication network or communications directly with other devices. The communication device may access a carrier provided by a station or access point, and transmit and/or receive communications on the carrier.

In the following certain examples are explained with reference to mobile communication devices capable of communication via a wireless cellular system and mobile communication systems serving such mobile communication devices. Before explaining in detail the examples of the disclosure, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a wireless communication system 100. The wireless communication system 100 may comprise one more devices 102 such as user equipments (UEs), or terminals. The wireless communication system 100 may also comprise a 5G system (5GS), as shown in Figure. The 5GS comprises a 5G radio access network (5G-RAN) 106, a 5G core network (5GC) 104 comprising one or more network functions (NF), one or more application functions (AFs) 108, and one or more data networks (DNs) 110.

The 5G-RAN 106 may comprise one or more gNodeB (gNB) distributed unit (DU) functions connected to one or more gNodeB (gNB) centralized unit (CU) functions.

The 5GC 104 may comprise an access management function (AMF) 112, a session management function (SMF) 114, an authentication server function (AUSF) 116, a user data management (UDM) 118, a user plane function (UPF) 120, a network exposure function (NEF) 122 and/or other NFs. Some of the examples as shown below may be applicable to 3GPP 5G standards. However, some examples may also be applicable to 5G-advanced, 4G, 3G and other 3GPP standards.

In a wireless communication system 100, such as that shown in FIG. 1, mobile communication devices/terminals or user apparatuses, and/or user equipments (UE), and/or machine-type communication devices are provided with wireless access via at least one base station or similar wireless transmitting and/or receiving node or point. The terminal is provided with an appropriate signal receiving and transmitting apparatus for enabling communications, for example enabling access to a communication network or communications directly with other devices. The communication device may access a carrier provided by a base station or access point, and transmit and/or receive communications on the carrier.

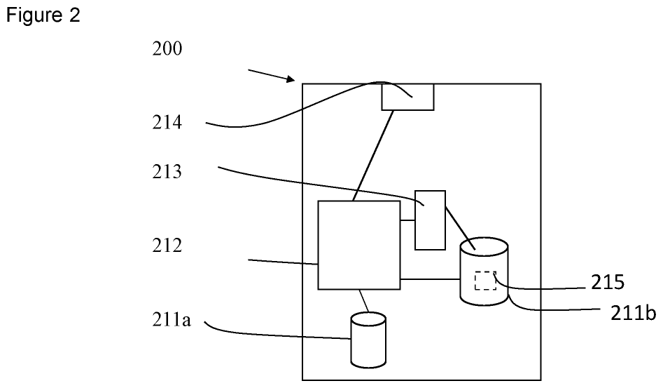

FIG. 2 illustrates an example of a control apparatus 200 for controlling a function of the 5G-RAN or the 5GC as illustrated on FIG. 1. The control apparatus may comprise at least one random access memory (RAM) 211a, at least one read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects or examples. The software code 215 may be stored in the ROM 211b. The control apparatus 200 may be interconnected with another control apparatus 200 controlling another function of the 5G-AN or the 5GC. In some examples, each function of the 5G-AN or the 5GC comprises a control apparatus 200. In alternative examples, two or more functions of the 5G-AN or the 5GC may share a control apparatus. The control apparatus 200 may comprise one or more circuits, or circuitry (not shown) which may be configured to perform one or more of the present aspects or examples.

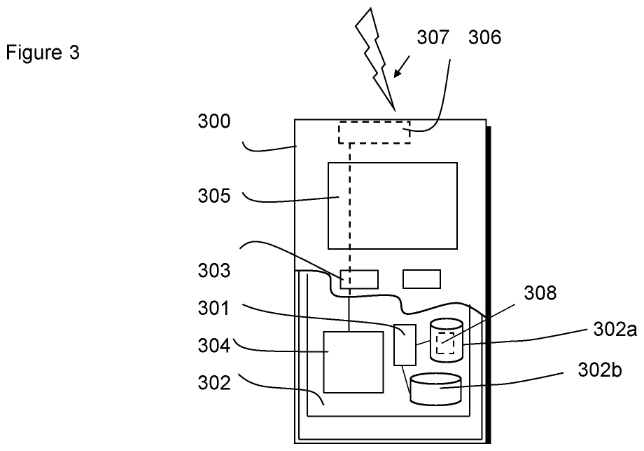

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a. The terminal 300 may comprise one or more circuits, or circuitry (not shown) which may be configured to perform one or more of the present aspects or examples.

The processor, storage and other relevant control apparatus may be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

Non-terrestrial networks (NTN) deliver new radio (NR) services via airborne or space-borne NTN entities. The NTN can provide much larger area coverage than a traditional terrestrial network and ensures connectivity in regions where current terrestrial networks are difficult or costly to cover, such as airplanes, vessels and remote rural areas. NTN architecture often comprises an NTN payload and an NTN gateway. An NTN payload is a network node, embarked on board a satellite or high-altitude platform station. An NTN gateway is a station located at the surface of the Earth, which is configured to provide connectivity to the NTN payload using a feeder link. The NTN payload is connected to one or more UEs via a service link.

Data transfer for devices located at remote sites or in remote areas is a common need. Research institutions may need to obtain data from remote sites for scientific research. For example, for animal tracking. Government agencies may need to obtain data from remote sites for disaster mitigation/avoidance. For example, via remote sensing. Commercial companies may obtain data from remote sites for resource allocation needs. Data transmission at remote sites often has large delays/high latency. Satellite coverage does not always ensure that satellites are connected to both a serving link and a feeder link. In previous years, many scholars have studied the data transmission problems at remote sites, and have developed store and forward modes/mechanisms to address the problem.

The store and forward operation in a 5G system with satellite access is intended to provide some level of communication service for UEs under satellite coverage with intermittent/temporary satellite connectivity for delay-tolerant communication service. For example, when the satellite is not connected via a feeder link. In store and forward operation, the signalling/data exchange between the UE and the satellite takes place without the satellite being simultaneously connected to a ground network (i.e., the satellite is able to operate the service link without an active feeder link connection).

In remote areas, there are often a lack of terrestrial networks for a number of reasons. For example, it is difficult to build and maintain communication towers (e.g. base stations). As a result, this makes it more challenging to collect information in these areas (e.g. for environmental protection purposes in these areas). For example, sensors installed on animals need to be monitored regularly. In this scenario, the sensors installed on the animals send the status information, e.g. the movements, physiology, and surrounding environment of the animals, to a satellite. The satellite stores the received status information of the animals and forwards the information to the scientific centre when a feeder link becomes available. This is referred to as a store and forward operation.

For example, scientific centres have installed sensors (e.g. internet of things (IoT) devices) on animals to collect information for environmental protection purposes in these remote areas. Astellas (trademark (™)), which is a satellite communication operator, have launched store and forward satellite operations in order to support data transferring in these remote areas. EA Science Center has signed contract with Satelles™ to allow sensors installed on animals to send the status information (e.g. the movements, physiology, and surrounding environment of the animals) to the EA Science Center via satellite. The satellite and the IoT devices installed on animals are configured with sufficient information (e.g. credentials/certificates) that is needed for the devices to verify the authenticity of the satellite.

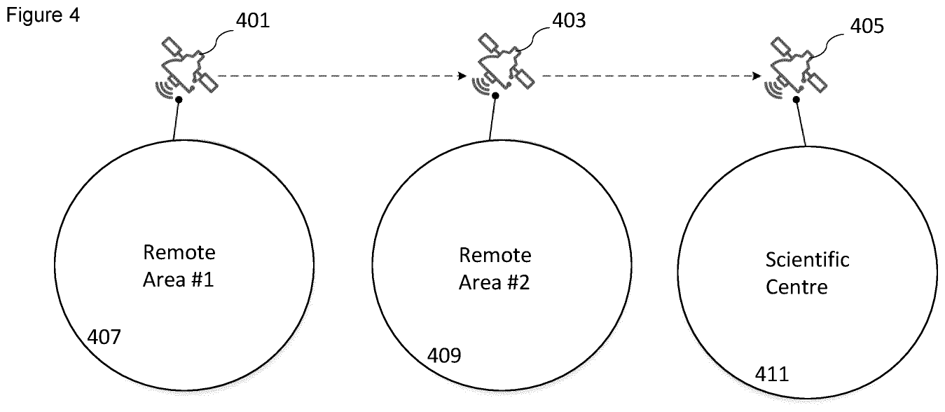

FIG. 4 shows a schematic representation of coverage areas for a non-terrestrial network.

A first satellite 401, a second satellite 403, a third satellite 405 are provided. The first satellite 401 is linked with the second satellite 403, as indicated with a dashed line. The second satellite 403 is linked with the third satellite 405. The link between satellites may be an inter-satellite link. The first 401, second 403, and third satellites 405 are in orbit above Earth.

The first satellite 401 is located so that it provides coverage for a first remote area 407. The second satellite 403 is located so that it provides coverage for a second remote area 409. The third satellite 405 is located so that it provides coverage for a scientific centre 411. Due to the rotation of Earth, the coverage provided by each satellite 401, 403, 405 changes over time.

IoT devices (now shown) are installed on animals in the first remote area 407 and the second remote area 409. Information generated by the IoT devices is to be used by the scientific centre 411.

When the IoT devices are installed on animals and powered on, the IoT devices are registered with a 5G network for store a forward (satellite) operation. Satellites with the store and forward capability enables the IoT devices to transfer data to the network, even when a feeder link to the ground is not available. A secured connection between an IoT device and the satellite is established for data security and privacy.

Each IoT device is configured to send sensor status information to a suitable satellite 401, 403, 405. The satellite 401, 403, 405 receiving the information stores the sensor status information received from the IoT device.

When the satellite 401, 403, 405 has a feeder link available to a ground 5G core (5GC) network, the satellite forwards the sensor status information, as well as other necessary information, to the 5GC. The 5GC verifies the IoT devices based on the information received. If it is verified, then the 5GC forwards the sensor status information to a destination data network.

The 5GC sends the result of the operation to the satellite 401, 403, 405 (the same satellite or a different one that will pass through the remote area).

When the satellite 401, 403, 405 (or a next satellite) passes through the first or second remote area 401, 403, the satellite 401, 403, 405 pages the device, and based on the result received from the 5GC, the satellite sends result of the operation to the IoT devices.

If an IoT device needs to update the sensor status information (i.e. sends further information), the IoT sends it to the satellite 401, 403, 405 when it is connected to the satellite 401, 403, 405. The satellite 401, 403, 405 stores the further information and forwards the further information to the 5GC, when a feeder link becomes available.

A similar operation may take place for other types of cellular system, such as 4G, 5G-Advanced, etc.

However, it is not clear how a 5G system could support the authentication and authorization for a UE, terminal, IoT device, etc, for store and forward operations. With current systems, there may be data privacy and security issues. This is likely to lead to routing problems for NTNs in the store and forward mode.

One or more of the examples below may aim to address one or more of the problems identified above.

In examples, there is an apparatus (e.g. a UE or communications device) configured for receiving an indication that a first satellite supports store and forward mode during a connection establishment with the first satellite, and then providing, to a gateway via the first satellite, a registration request comprising: i) a non-terrestrial network subscription concealed identifier, and ii) an indication of store and forward mode, wherein the subscription concealed identifier comprises an identifier for a non-terrestrial network gateway. The apparatus also configured for communicating with the first satellite using a store and forward mode. This is described in more detail below.

In this way, in examples, there is provided a ‘new’ network access identifier (NAI) format for NTN-specific subscription concealed identifiers (SUCI) with a ‘new’ field called ‘NTN gateway identifier’ that is included in the SUCI. The ‘NTN gateway identifier’ is retrieved by each satellite connected via inter satellite link (ISL) to route messages to the correct NTN gateway. During a connection establishment between a UE and a satellite, the satellite indicates to the UE that (only) store and forward mode is supported at the satellite. This allows the NTN gateway to be identified and verified. The ‘NTN gateway identifier’ may be pre-provisioned in USIM, similar to other parameters like a home network (HN) public key or protection scheme or routing identity. Operators may use legacy procedures like over-the-air (OTA) or steering of roaming (SoR) to update the pre-provisioned NTN gateway identifier for SUCI generation. SoR and UE parameter update (UPU) are two procedures in 5G that occur between UEs/mobile devices/mobile phones and a home network. These procedures enable the home network to update configuration parameters in UEs/mobile devices/mobile phones and/or a universal subscriber identity module using control plane signalling

In examples, the registration request provided by the user equipment includes a new field indicating that current satellite supports store and forward mode. A UDM then authorizes the use of store and forward mode.

In examples, the ‘NTN gateway identifier’ is retrieved by each satellite to route the message to the correct NTN gateway.

In examples, the NTN gateway verifies the received SUCI with the ‘NTN gateway identifier’.

These examples will be described in more detail below, alongside the following figures.

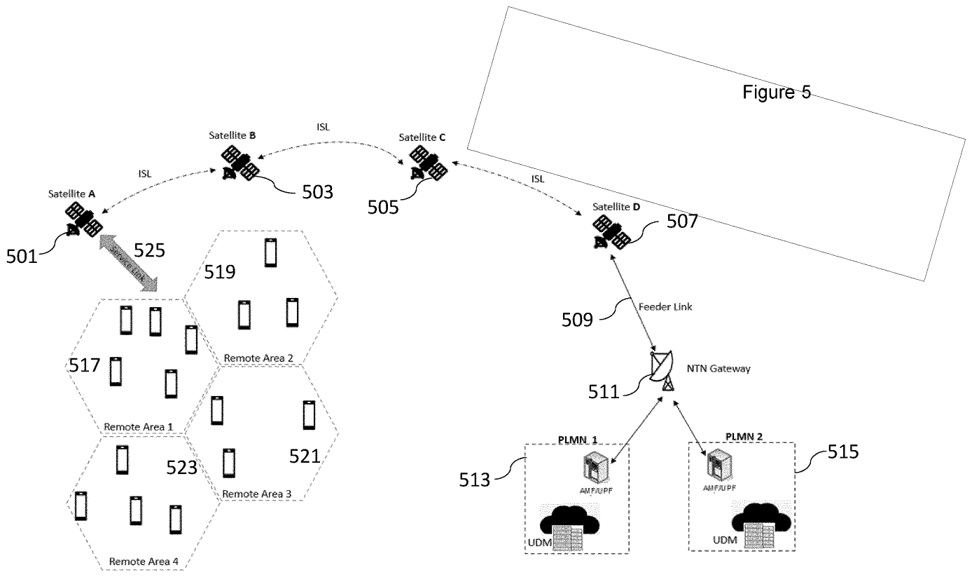

FIG. 5 shows a schematic representation of a system-level view of a non-terrestrial network communicating with a terrestrial network.

As shown in FIG. 5, the system comprises a satellite A 501, a satellite B 503, satellite C 505, a satellite D 507. Satellite A 501 is linked to satellite B 503. Satellite B 503 is linked to satellite C 505. Satellite C 505 is linked to satellite D 507. The satellites are linked with ISLs.

Satellite A 501, satellite B 503, and satellite C 505 do not have a feeder link to a terrestrial network. Satellite D 507 has a feeder link 509 to an NTN gateway 511. The NTN gateway 511 is connected to a first public land mobile network (PLMN) 513 and a second PLMN 515. Each PLMN 513, 515 comprises an AMF/UPF and a UDM (as well as other network entities and functions, not shown).

There are provided four remote areas including a first remote area 517, a second remote area 519, a third remote area 521, and a fourth remote area 523. Each of the remote areas comprise a plurality of devices. Satellite A 501 has a service link 525 with at least one of the remote areas 517, 519, 521, 523.

As illustrated in FIG. 5, devices such as UEs or IoT devices in the first 517, second 519, third 521 and fourth remote 523 areas are connected to Satellite A 501. Satellite A 501 is connected to other satellites B 503, C 505 via ISL but these satellites do not have an NTN gateway or feeder link established at the same time as the service link 525.

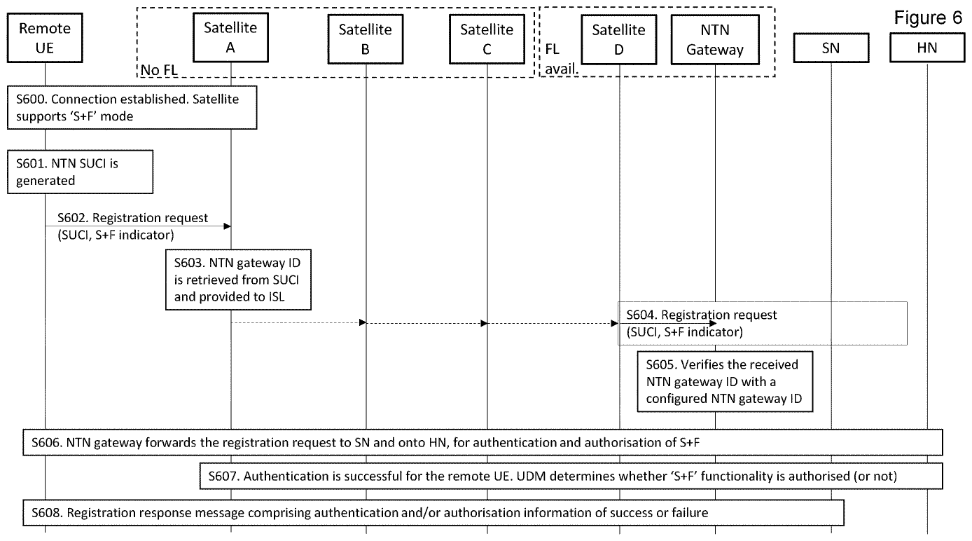

The various entities within the system of FIG. 5 may communicate with each other. An example of such a communication is shown in the signalling diagram of FIG. 6.

FIG. 6 shows an example signalling diagram between a user equipment, non-terrestrial network entities, and terrestrial network entities.

When a UE does not have a terrestrial network connection and is able to connect to satellite A (i.e. an NTN) which does not have a feeder link to NTN gateway, the following signalling may occur:

At S600, a connection is established between a UE and a first satellite (referred to as ‘satellite A’). Satellite A provides an indication to the UE that satellite A supports store and forward mode during the connection establishment.

The indication may be that the satellite A only supports store and forward mode. The indication may be an update from the satellite A. Said another way, the UE already knows some functionality of satellite A, and the indication provides an update of the functionality.0

The UE may be referred to as a remote UE, due to the current location of the UE. As a remote UE, the UE may not be connected to a terrestrial/ground network.

At S601, in response to receiving the indication, the UE generates a non-terrestrial network (NTN) subscription concealed identifier (SUCI). The UE generates the NTN SUCI to include an identifier for an NTN gateway. The identifier for the NTN gateway may be termed an ‘NTN gateway ID’, in some examples. In other examples, any other suitable name is used. The NTN SUCI is associated with the UE.

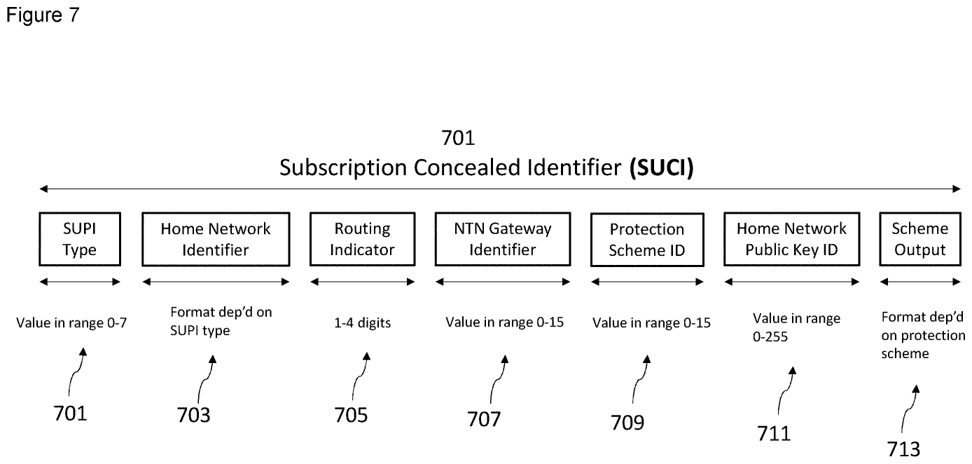

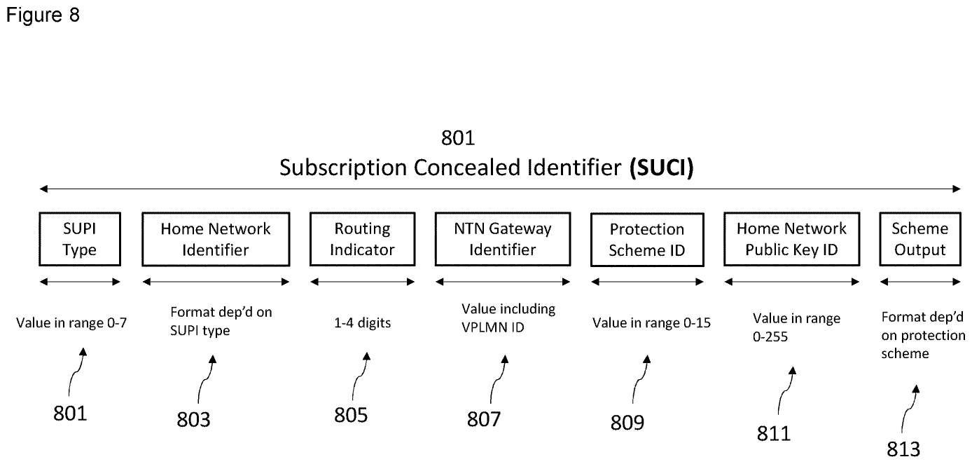

The generation of the NTN SUCI is described in more detail below, alongside FIGS. 7 and 8.

At S602, the UE provides a registration request message to satellite A. The registration request message comprises the generated SUCI. The registration request message comprises an indication of store and forward mode. The registration request is addressed to an NTN Gateway (but routed to the NTN gateway via “N” number of satellites). The indication of store and forward mode may be considered to be a request for store and forward mode.

The SUCI may be generated with an NTN SUCI context in a universal integrated circuit card (UICC). Said another way, a SUPI is concealed to generate the SUCI, wherein the generation happens in the UICC.

At S603, satellite A retrieves the NTN gateway ID from the registration request message. The NTN gateway ID being found in the SUCI.

Satellite A does not have a feeder link to connect satellite A to an NTN gateway. Satellite A uses the NTN gateway ID to determine where to route the registration request message to.

Based on the determination, satellite A forwards the registration request message to satellite B. Satellite B then forwards the registration request message to satellite C. Satellites B and C also do not have feeder links.

Satellite C may be connected to two or more different satellites. For example satellite D and further satellites. Satellite C checks/determines which satellite can route the registration request message to the correct NTN Gateway (as per the SUCI).

Based on the check/determination, satellite C forwards the registration request message to satellite D, which does have a feeder link to the (correct) NTN gateway.

At S604, satellite D receives the registration request message and provides it to the NTN gateway via the feeder link.

At S605, the NTN gateway proceeds to verify the NTN gateway ID comprised within the SUCI. The NTN gateway verifies the NTN gateway ID using a configured NTN gateway ID. The NTN gateway may determine whether the NTN gateway ID of the registration request message matches the NTN gateway that receives it. Said another, the NTN gateway determines whether the registration request message has been sent to the correct NTN gateway.

At S606, following a successful verification, the NTN gateway forwards the registration request message to a serving network (SN) and onto a home network (HN). The registration request message is forward to the terrestrial network (i.e. SN/HN) for authentication and authorisation purposes.

The authentication procedure in the SN and HN may be the same as FIG. 6.1.2-1 and FIG. 6.1.3.1-1 of 3GPP TS 33.501.

At S607, the HN has performed the authentication for the UE, and the then performs authorisation for the store and forward mode.

After a successful authentication for the UE, an AUSF and/or a UDM determines whether store and forward mode (as per the indication) is authorized. The determination may be based on the NTN gateway ID. The AUSF and/or the UDM are comprised within the HN.

At S608, a registration response message is provided by the SN. The registration response message comprises success/failure information indicating that authentication and authorization has succeeded/failed. The registration response message is sent to the UE by the SN, via the satellite A.

In some examples, after a successful authorization of the store and forward mode, the SN forwards information associated with i) the result of authentication of the UE, and ii) the authorization of store and forward mode to satellite A. The information is provided via other satellites, i.e. via satellites B, C and D. A similar procedure may be repeated for other remote UEs of the same PLMN, or different PLMNs.

Following receipt of the information, the UE and satellite A are able to communicate using a store and forward mode. Said another way, the UE and satellite A can perform store and forward operations for data transmission (from the UE).

In some examples, the NTN gateway ID is also considered in an authentication and key agreement (AKA) challenge, key generation, or any other key-related process in the UDM. Similar to a serving network name (SNN) used for terrestrial cases, here for satellite use cases, NTN gateway ID is used to link the NTN gateway ID and the NTN gateway to a particular UE's authentication. In terrestrial networks, an AMF initiates an authentication by sending an Authenticate Request message with SUCI or SUPI (in case of valid 5G-GUTI) and the serving network name (SNN) to an AUSF. Subsequently, SNN is used along with other parameters to verify the authentication response.

In some examples, even though satellite A moves (with respect to the Earth) after the authentication, the UE is connected via the NTN gateway. After successful authentication, the NTN gateway ID may be stored in UDM for future connections and/or other services.

It should be understood that one or more of the steps above may not be performed in some examples, or may be performed in a different order.

It should be understood that the example signalling is applicable for any suitable device which can communicate with satellite A. For example, a IoT device, a terminal, a user device, a tablet, etc.

FIG. 7 shows a schematic representation of a subscriber concealed identifier (SUCI).

There is provided a SUCI 700 which supports an NTN gateway. A visitor PLMN (VPLMN) or home PLMN (HPLMN) default NTN gateway ID may be provided.

The SUCI 700 comprises the following parts:
i) A subscription permanent identifier (SUPI) type 701 which has a value in the range of 0 to 7. The SUPI type 701 identifies the type of the SUPI concealed in the SUCI. The following values may be defined for the SUPI type: 0: International mobile subscriber identity (IMSI), 1: Network specific identifier (NSI), 2: Global line identifier (GLI), 3: Global cable identifier (GCI), 4: NTN gateway identifier, 5 to 7: spare values for future use. In this example, the NTN gateway identifier is comprised in the SUPI type field. In this example, the NTN gateway identifier is provided in value 4 of the SUPI type. In other examples, the NTN gateway identifier is provided in another of the spare values. In other examples, the NTN gateway identifier is not comprised within the SUPI type field.
ii) A home network identifier 703. The home network identifier has a format that is dependent on the SUPI type 701.
iii) A routing indicator 705. The routing indicator is between 1 and 4 digits.
iv) An NTN gateway identifier 707. The NTN gateway identifier 707 has a value in the range of 0 to 15. In some examples, the NTN gateway identifier 707 is comprised in the SUPI type field, as described above. In other examples, the NTN gateway identifier 707 is comprised in a different field/part of the SUCI 700.
v) A protection scheme ID 709. The protection scheme ID 709 has a value in the range of 0 to 15.
vi) A home network public key ID 711. The home network key ID 711 has a value in the range of 0 to 255.
vii) A scheme output 713. The scheme output 713 has a format that is dependent on the protection scheme 709.

When the SUPI is defined as a network specific identifier, the SUCI may take the form of a network access identifier (NAT). In this case, the NAI format of the SUCI may have the form of, for example, username@realm as specified in clause 22 of IETF RFC 2542, where the realm part shall be identical to the realm part of the Network Specific Identifier. In a standalone non-public network (SNPN) scenarios, the realm part of the NAI may include mobile country code (MCC), mobile network code (MNC) and the network ID (NID) of the SNPN (see 3GPP TS 23 501 clauses 530.23,530 29,634, and 63.8, for the realm part format see Home Network Domain for an SNPN clause 12).

When the SUPI is defined as an IMSI, the SUCI in NAI format may have the form of, for example, username@realm, wherein the realm part is constructed by converting the leading digits of the international mobile subscriber identity (IMSI), i.e., MNC and MCC, into a domain name, as described in clause 28.2.

A valid SUPI may be in one of two different formats. A first format of an IMSI comprising MCC+MNC+MSIN (as defined in TS 23.003 for 3GPP RAT). For example, 432 35 123456789. A second format of an NAI (as defined in RFC 4282 based user identification as defined in TS 23.003 for non-3GPP RAT). For example, it may be based on IMSI. For inter-working with EPC, the SUPI is to be based on IMSI. e.g. alice@operator.com, or 43235123456789@operator.com.

In SNPN scenarios, the realm part shall additionally include the network ID (NID) of the SNPN. The resulting realm part of the NAI may be in the form:

```
      “5gc.mnc<MNC>.mcc<MCC>.3gppnetwork.org”, or
      “5gc.nid<NID>.msc<MNC>.mcc<MCC>.3gppnetwork.org” (for SNPN
scenarios)
```

The username part of the NAI shall take one of the following forms:
a) for the null scheme:

type<supi type>.rid<routing indicator>.ntngwid.<NTN Gateway id>.schid<protection
scheme id>.userid<MSIN or Network Specific Identifier SUPI username>

b) for the scheme output for elliptic curve integrated encryption scheme profile A and profile B:

type<supi type>.rid<routing indicator>.ntngwid.<NTN Gateway id>.schid<protection
scheme id>.hnkey<home network public key id>.ecckey<ECC ephermeral public key
value>.cip<ciphertext value>.mac<MAC tag value>

c) for HPLMN proprietary protection schemes:

type<supi type>.rid<routing indicator>.ntngwid.<NTN Gateway id>.schid<protection
scheme id>.hnkey<home network public key id>.out<HPLMN defined scheme output>

FIG. 8 shows a further schematic representation of a subscriber concealed identifier.

There is provided a SUCI 800 which supports an NTN gateway. The SUCI 800 comprises the following parts:
i) A subscription permanent identifier (SUPI) type 801 which has a value in the range of 0 to 7. The SUPI type 801 identified the type of the SUPI concealed in the SUCI. The following value are defined: 0: IMSI, 1: Network specific identifier (NSI), 2: Global line identifier (GLI), 3: Global cable identifier (GCI), 4: NTN gateway identifier, 5 to 7: spare values for future use.
ii) A home network identifier 803. The home network identifier has a format that is dependent on the SUPI type 801.
iii) A routing indicator 805. The routing indicator is between 1 and 4 digits.
iv) An NTN gateway identifier 807. The NTN gateway identifier 807 has a value included in a VPLMN ID.
v) A protection scheme ID 809. The protection scheme ID 809 has a value in the range of 0 to 15.
vi) A home network public key ID 811. The home network key ID 811 has a value in the range of 0 to 255.
vii) A scheme output 813. The scheme output 813 has a format that is dependent on the protection scheme 809.

A list of NTN gateway identifiers may be configured by a HPLMN in a universal subscriber identity module (USIM). An NTN gateway identifier 807 may be a default value of a HPLMN. Alternatively, the NTN gateway identifier 807 may be a list of preferred VPLMN gateway IDs.

As shown in FIG. 5, the satellites A 501, B 503 and C 505 do not have a feeder link to a terrestrial network. Satellite D has the feeder link 509 with the (VPLMN) NTN gateway 511. In this way, the Satellite A 501 is connected to the VPLMN NTN gateway 511 via satellites B, C and D, with the UE identity being sent to the VPLMN in a SUCI or a 5G globally unique temporary identifier (5G-GUTI). Said another way, the SUCI or 5G GUTI of a UE located in a remote area 517, 519, 523 521 connected to satellite A 501 with service link 525 is being sent to the NTN gateway 511 via satellite B 503, satellite C 505, satellite D 507 and the feeder link 509. The 5G-GUTI is a temporary identity, so it does not have a fixed association with a specific subscriber nor device. The use of a temporary identity helps to improve privacy. The allocated 5G-GUTI may be changed at any time. A 5G SUPI may be: an IMSI, an NAI, a SUCI that allows the SUPI to be signalled without exposing the identity of the user. In this way, the SUCI is permanent whereas the 5G-GUTI is temporary.

There may be many NTN gateways within one VPLMN or one HPLMN. Therefore, an NTN gateway ID may be used to differentiate between the NTN gateways between the VPLMN/HPLMN.

As shown in FIG. 8, in examples, a VPLMN ID is included along with the NTN gateway ID 807, such as a VPLMN ID and a NTN GW ID.

In order to differentiate whether the NTN gateway ID is an HPLMN or VPLMN NTN gateway ID, a single bit may be used to differentiate between them.

For example, bits 7 to 1 represents the NTN gateway ID, with bit 8 representing a VPLMN or a HPLMN. Table 1 shows an example wherein the 8th bit set to 0 indicates a VPLMN, and a 1 indicates a HPLMN.

TABLE 1
Example values for NTN gateway identities including an identifier for a VPLMN or HPLMN.

| Bit | | | | | | | | |
|---|---|---|---|---|---|---|---|---|
| 8 | 7 | 6 | 5 | 4 | 3 | 2 | 1 | Notes |
| 1 | 0 | 0 | 0 | 0 | 0 | 0 | 1 | HPLMN NTN |
| | | | | | | | | gateway ID 1 |
| 0 | 0 | 0 | 0 | 0 | 0 | 0 | 1 | VPLMN NTN |
| | | | | | | | | gateway ID 1 |
| 1 | 0 | 0 | 0 | 0 | 0 | 1 | 0 | HPLMN NTN |
| | | | | | | | | gateway ID 2 |
| 0 | 0 | 0 | 0 | 0 | 0 | 1 | 0 | VPLMN NTN |
| | | | | | | | | gateway ID 2 |
| . . . | | | | | | | | |
| 0 | 1 | 1 | 1 | 1 | 1 | 1 | 1 | VPLMN NTN |
| | | | | | | | | gateway ID 127 |

In the example of Table 1, there are 7 bits that are used for the different gateway IDs. This means that there are 127 different gateway IDs that are possible, with the eighth bit for VPLMN or HPLMN. It should be understood that this is an example only. In other examples, an NTN gateway ID may have more or less than 8 bits.

The 5G-GUTI may be used to support subscriber identity confidentiality. In a shortened 5G S-temporary mobile subscriber identity (5G-S-TMSI) form, the 5G-GUTI may enable more efficient radio signalling procedures (e.g. paging and service requests) for satellite coverage UEs.

The format and size of the 5G-GUTI may be, for example, the following:

```
    <5G-GUTI-SAT> = < GUAMI-SAT><5G-TMSI>,
    where <GUAMI-SAT> = < MCC><MNC><AMF Identifier><NTN Gateway
Identifier>,
    and where <AMF Identifier> = <AMF Region ID><AMF Set ID><AMF Pointer>
```

The MCC and MNC may have the same field size as in earlier 3GPP systems. The MCC may comprise three digits. The MNC may comprise two or three digits for 3GPP network applications. If it is considered that 1 digit=4 bits, then 3 digits would map to 12 bits.

The ‘5G-TMSI’ may be 32 bits in length. The ‘AMF Region ID’ may be 8 bits in length. The ‘AMF Set ID’ may be 10 bits in length. The ‘AMF Pointer’ may be 6 bits in length.

The ‘NTN Gateway Identifier’ shall be of 8 bits length.

In examples, a ‘new’ NAI format is provided for NTN-specific SUCI, with a field, “NTN Gateway Identifier”, being included in the SUCI. The NTN gateway identifier is retrieved by each satellite connected via ISL to route messages to the correct NTN gateway. During connection establishment, between a satellite and a UE, the satellite updates the UE to indicate that only store and forward mode is supported.

The UE sends a registration request including a field indicating that the current satellite only supports store and forward functionality and the UDM should authorize it. In the absence of this indicator, a ‘normal mode’ will be operated where the satellite already has a connection with the gateway.

The HN authenticates the UE, and also authorizes the store and forward functionality.

Therefore, one or more of the examples have the advantage that the mechanism addresses the routing problem for NTNs with the “store and forward” mode.

Furthermore, one or more of the examples work as an extension of existing procedures that are already standardized, which ensures seamless integrations with the authentication for store-and-forward scenarios. This enables additional authorization at AUSF/UDM for NTN store-and-forward scenarios.

One or more examples allows the network to distinguish between NTN-specific store-and-forward scenarios and other NTN or terrestrial network scenarios. This can be used to improve timer controls at the network in such cases whereby a feeder link is not available at the first connected satellite, as it can take longer for the signals and data to reach the network.

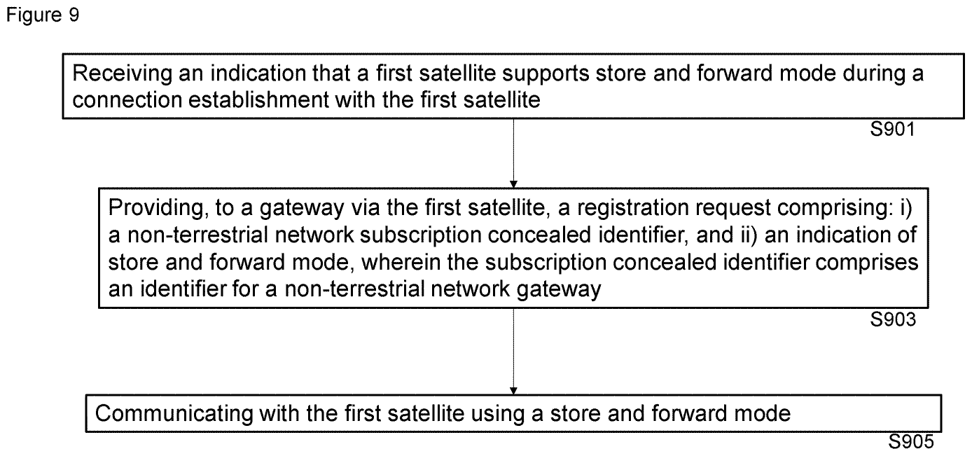

FIG. 9 shows an example method flow performed by an apparatus. The apparatus may comprise means for performing one or more of the following steps. The apparatus may be for a UE. The apparatus may be comprised in a UE. The apparatus may be a UE.

In S901, the method comprises receiving an indication that a first satellite supports store and forward mode during a connection establishment with the first satellite.

In S903, the method comprises providing, to a gateway via the first satellite, a registration request comprising: i) a non-terrestrial network subscription concealed identifier, and ii) an indication of store and forward mode, wherein the subscription concealed identifier comprises an identifier for a non-terrestrial network gateway.

In S905, the method comprises communicating with the first satellite using a store and forward mode.

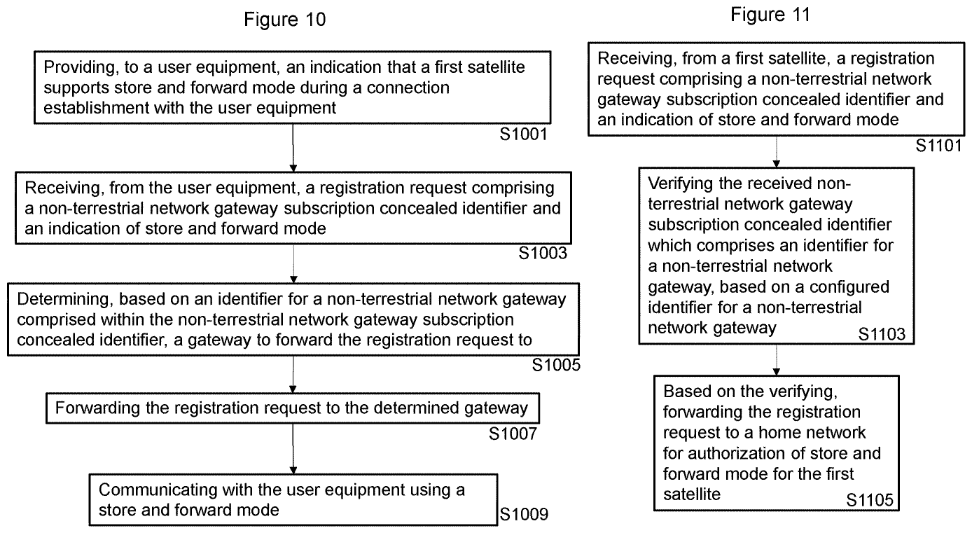

FIG. 10 shows an example method flow performed by an apparatus. The apparatus may comprise means for performing one or more of the following steps. The apparatus may be for a first satellite. The apparatus may be comprised in a first satellite. The apparatus may be a first satellite.

In S1001, the method comprises providing, to a user equipment, an indication that a first satellite supports store and forward mode during a connection establishment with the user equipment.

In S1003, the method comprises receiving, from the user equipment, a registration request comprising a non-terrestrial network gateway subscription concealed identifier and an indication of store and forward mode.

In S1005, the method comprises determining, based on an identifier for a non-terrestrial network gateway comprised within the non-terrestrial network gateway subscription concealed identifier, a gateway to forward the registration request to.

In S1007, the method comprises forwarding the registration request to the determined gateway.

In S1009, the method comprises communicating with the user equipment using a store and forward mode.

FIG. 11 shows an example method flow performed by an apparatus. The apparatus may comprise means for performing one or more of the following steps. The apparatus may be for a gateway. The apparatus may be comprised in a gateway. The apparatus may be a gateway.

In S1101, the method comprises receiving, from a first satellite, a registration request comprising a non-terrestrial network gateway subscription concealed identifier and an indication of store and forward mode.

In S1103, the method comprises verifying the received non-terrestrial network gateway subscription concealed identifier which comprises an identifier for a non-terrestrial network gateway, based on a configured identifier for a non-terrestrial network gateway.

In S1105, the method comprises, based on the verifying, forwarding the registration request to a home network for authorization of store and forward mode for the first satellite.

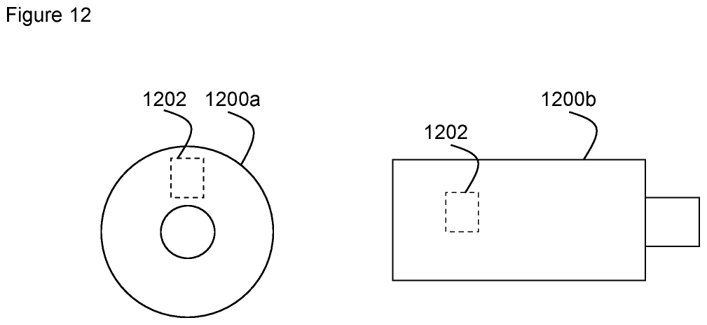

FIG. 12 shows a schematic representation of non-volatile memory media 1200a (e.g. computer disc (CD) or digital versatile disc (DVD)) and 1200b (e.g. universal serial bus (USB) memory stick) storing instructions and/or parameters 1202 which when executed by a processor allow the processor to perform one or more of the steps of the methods of FIG. 9, FIG. 10 or FIG. 11.

It is noted that while the above describes example embodiments, there are several variations and modifications which may be made to the disclosed solution without departing from the scope of the present invention.

The examples may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The term “non-transitory”, as used herein, is a limitation of the medium itself (i.e. tangible, not a signal) as opposed to a limitation on data storage persistency (e.g. RAM vs ROM).

As used herein, “at least one of the following: <a list of two or more elements>” and “at least one of: <a list of two or more elements>” and similar wording, where the list of two or more elements are joined by “and”, or “or”, mean at least any one of the elements, or at least any two or more of the elements, or at least all of the elements.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

Alternatively, or additionally some examples may be implemented using circuitry or means for performing a step/steps. The ‘circuitry’ or ‘means’ may be configured to perform one or more of the functions and/or method steps previously described. That circuitry or means may be provided in a satellite, a gateway, a base station, a UE and/or in a communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device. The term circuitry also covers, for example and if applicable to the particular claim element, a baseband integrated circuit or processor integrated circuit for a mobile device or a similar integrated circuit in a server, a cellular network device, or other computing or network device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1-25. (canceled)

26. An apparatus comprising:
at least one processor; and
at least one memory storing instructions that, when executed by the at least one processor, cause the apparatus at least to perform:
receiving an indication that a first satellite supports store and forward mode during a connection establishment with the first satellite;
providing, to a gateway via the first satellite, a registration request comprising: i) a non-terrestrial network subscription concealed identifier, and ii) an indication of store and forward mode, wherein the subscription concealed identifier comprises an identifier for a non-terrestrial network gateway; and
communicating with the first satellite using a store and forward mode.

27. The apparatus according to claim 26 further caused to perform:
based on the indication, generating the subscription concealed identifier, wherein the identifier for a non-terrestrial network gateway is included in the subscription concealed identifier.

28. The apparatus according to claim 26, wherein the subscription concealed identifier is part of a network access identifier.

29. The apparatus according to claim 26, wherein the identifier for the non-terrestrial network gateway is configured in a universal subscriber identity module.

30. The apparatus according to claim 26, wherein the indication of support for the store and forward mode comprised in the registration request message further indicates for a unified data management function to authorize the store and forward mode for communication between a user equipment and the first satellite.

31. The apparatus according to claim 26 further caused to perform:
receiving authorisation information that the store and forward mode has been authorised; and
wherein the apparatus is caused to perform the communicating comprises:
in response to receiving the authorisation information, the apparatus caused to communicating with the first satellite using a store and forward mode

32. The apparatus according to claim 26, wherein the identifier for the non-terrestrial network gateway comprises information associating the identifier for the non-terrestrial network gateway with one of: a home public land mobile network, and a visited public land mobile network.

33. The apparatus according to claim 26, wherein the identifier for the non-terrestrial network gateway is comprised in a 5G globally unique temporary identifier.

34. An apparatus comprising:
at least one processor; and
at least one memory storing instructions that, when executed by the at least one processor, cause the apparatus at least to perform:
providing, to a user equipment, an indication that a first satellite supports store and forward mode during a connection establishment with the user equipment;
receiving, from the user equipment, a registration request comprising a non-terrestrial network gateway subscription concealed identifier and an indication of store and forward mode;
determining, based on an identifier for a non-terrestrial network gateway comprised within the non-terrestrial network gateway subscription concealed identifier, a gateway to forward the registration request to;
forwarding the registration request to the determined gateway; and
communicating with the user equipment using a store and forward mode.

35. The apparatus according to claim 34, wherein the registration request is provided to the gateway via a second satellite.

36. The apparatus according to claim 34, wherein the indication of support for the store and forward mode comprised in the registration request message further indicates for a unified data management function to authorize the store and forward mode for communication between a user equipment and the first satellite.

37. The apparatus according to claim 34 further caused to perform:
receiving, from a serving network, authorisation information that the store and forward mode has been authorised; and
forwarding, to the user equipment, the authorisation information.

38. The apparatus according to claim 34, wherein the identifier for the non-terrestrial network gateway comprises information associating the identifier for the non-terrestrial network gateway with one of: a home public land mobile network, and a visited public land mobile network.

39. An apparatus comprising:
at least one processor; and
at least one memory storing instructions that, when executed by the at least one processor, cause the apparatus at least to perform:
receiving, from a first satellite, a registration request comprising a non-terrestrial network gateway subscription concealed identifier and an indication of store and forward mode;
verifying the received non-terrestrial network gateway subscription concealed identifier which comprises an identifier for a non-terrestrial network gateway, based on a configured identifier for a non-terrestrial network gateway; and
based on the verifying, forwarding the registration request to a home network for authorization of store and forward mode for the first satellite.

40. The apparatus according to claim 39, wherein the registration request is received from the first satellite via a second satellite.

41. The apparatus according to claim 39, wherein the subscription concealed identifier is part of a network access identifier.

42. The apparatus according to claim 39, Wherein the indication of support for the store and forward mode comprised in the registration request message further indicates for a unified data management function to authorize the store and forward mode for communication between a user equipment and the first satellite.

43. The apparatus according to claim 39 caused further to perform:
providing, to the first satellite, authorisation information that the store and forward mode has been authorised.

44. The apparatus according to claim 39, Wherein the identifier for the non-terrestrial network gateway comprises information associating the identifier for the non-terrestrial network gateway with one of: a home public land mobile network, and a visited public land mobile network.
